(19) United States
(12) Patent Application Publication
(10) Pub. No.: US 2018/0352130 A1
(43) Pub. Date: Dec. 6, 2018

(54) Smart Phone Viewfinder

(71) Applicants: Robert B. Zajeski, Homer Glen, IL (US); Ben L. Zajeski, Plainfield, IL (US)

(72) Inventors: Robert B. Zajeski, Homer Glen, IL (US); Ben L. Zajeski, Plainfield, IL (US)

(21) Appl. No.: 15/977,516

(22) Filed: May 11, 2018

Related U.S. Application Data
(60) Provisional application No. 62/505,304, filed on May 12, 2017.

(51) Int. Cl. H04N 5/225; H04N 5/232; G06F 1/16; G03B 17/56

(52) U.S. Cl. CPC H04N 5/22525; H04N 5/2254; G03B 17/565; G06F 1/1686; H04N 5/23216

(57) ABSTRACT

The smart phone viewfinder comprises a tubular body mounted on a screen for a smart phone to provide a light sealed sight channel between an eye-cup and a hood bearing against the screen on the inside and a phone app for adapting the image captured by the phone camera lens to be viewable in the viewfinder. The light sealed channel provides visual communication from the eye-cup to the screen. A software application executable on the phone may be adapted to adjust the size and position of the image visible through the light sealed sight channel. The software application is further adapted to select and position icons on the screen for camera control. The light sealed sight channel adapted to reduce ambient light.

### RELATED APPLICATIONS

This application is a continuation of co-pending U.S. Provisional Application Ser. No. 62/505,304, filed May 12, 2017 entitled Smart Phone Viewfinder. Application Ser. No. 62/505,304 is hereby incorporated into this Non-Provisional application in its entirety.

### FIELD OF THE INVENTION

The present invention relates generally to cell phone accessories for taking pictures using the camera function in a mobile phone and the like.

### BACKGROUND OF THE INVENTION

The inventors have come to realize from their own experience taking photos or video using a smartphone is difficult outside in bright or sunny conditions. The image is difficult to see on the smartphone screen. Several existing methods using shades that fully or partially encompass the smartphone screen exist but still allow light onto the screen making it difficult to view. Also, the average distance from the human eye to the screen is such that the screen would have to be 25-35 cm away from the eye to maintain focus. Having shades span this distance makes holding the smartphone awkward and does not allow the user to access any controls on the smartphone screen.

Viewfinders have been around for years on film and digital cameras allowing the operator to place their eye into an eyepiece and view the image to be captured thru the camera lens. These viewfinders use optics to place the image at a comfortable optical distance for viewing and may use a removable eyepiece to reduce ambient light.

The invention will be described as use with a smart phone. Using a viewfinder on a smartphone creates several challenges. First it is difficult to enclose the smartphone screen in a hood since there are numerous screen sizes. In addition, the phone controls and camera controls are icons on the screen and are difficult to see and manipulate with a hood over the screen. The hood must be able to place the user close enough to see the image detail while also viewing the entire image to adjust for layout of the subject matter.

It is desired to provide a viewfinder for use with a phone, also referred to as a smartphone, having a software application, a display screen, a camera function and an optical device removably mounted on the phone. Software application may be a smart phone app for enabling viewfinder optical device by manipulating the image to a size and position to allow the user to view detail of the image while viewing the entire image to optimize the captured image. The software application may be adapted to modify the size and position of the image on the screen. The software application may also enable control icons and locate the icons in usable, viewable locations on the screen. Phone and camera function controls are displayed as icons on the screen. Viewfinder may be adapted to allow a user to view an image to be captured while allowing access to camera controls.

Optical device may be removably mounted on phone for steady operation and to space phone from user's face to prevent inadvertent contact between user and phone. The optical device may be a light channel removably and adjustably affixed to the smartphone screen. The light channel may have an eye-cup and a screen hood. The eye cup may be adapted to engage the user's face adjacent the user's eye to surround and light isolate the user's eye. The eye-cup maybe adapted to prevent ambient light from entering at the interface between the users face and the eye-cup. The eye-cup may be adjustably attached to the light channel to space the eye-cup a predetermined distance from the screen and focus the camera on the image. The predetermined distance is selected to view the image and prevent contact between the user's face, particularly the users nose and the screen. The hood extends from the light channel in the optical device to engage the screen area surrounding the image. The viewing area is through the optical device from the eye-cup, through the light channel to the hood to view the image clearly by preventing ambient light distortion of the image. Optical device is removably attached to phone by clamp adapted to position optical device for use. Hood is placed to surround image and eye-cup is spaced from screen a predetermined distance.

The software application and the optical device work together to adjust the image for viewing through the optical device and to position the reduced image spaced from camera control icons on the screen for user access. The reduced image size allows a small hood on the screen leaving screen space for control icons. The light isolating viewfinder with elastomeric eye-cup light channel and hood encloses the operator's eye to seal out and unwanted light.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is a perspective view of the viewfinder mounted on a smartphone.

FIG. 2 is a perspective exploded view of the viewfinder and the smartphone.

FIG. 3 is a back perspective of the viewfinder.

FIG. 4 is a front view of the smartphone having a full screen size image displayed.

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Referring to FIG. 1, the invention comprises a viewfinder 12 for a smartphone 12 comprising a software application and an eyepiece 14. Eyepiece may be adjustably and removably held to smartphone 12 by clamp 16. Eyepiece 14 comprises a body 18, a hood 20, a sight channel 26 and an eye-cup 22. Optical lens 25 is mounted in eyepiece 14 on sight channel 26 adjacent eye-cup 22. Eye-cup 22 may be adjustably attached to body 18 to position eye-cup 22 a predetermined distance from screen 34 or to focus lens 25 on image 46. Eye-cup 22 may be slidably of threadably traversed along threadable engagement to adjust spacing between eye-cup 22 and screen 34. Hood 20 may be threadbly attached to body 18. Hood 20 may be threadably traversed along threadable engagement with body 18 to adjust spacing between hood 20 and screen 34. Hood 20 may be clamped in position. Hood 20 may have resilient, light proof pad 35 bearing against screen 34.

Continuing to refer to FIG. 1, clamp 16 may comprise a first grip 24, a clamp body 28, a second grip 30 and clamping rods 38. Clamping rods 38 may extend adjustably between first grip 24 and clamp body 28. Clamping rods 38 may also extend adjustably from clamp body 28 to second grip 30. Clamping rods 38 may be releasably attached to clamp body 28. Clamping rods 38 extend into channels 40 in clamp body 28 having fasteners 42 threadably attached to and extending into clamp body 28 and bearing against clamping rods 38 to releasably hold clamping rod 38 in a predetermined position with respect to clamp body 28 to adjustably attach eyepiece 14 to phone 12 having hood 20 disposed on screen 34. Clamp 16 may further comprise tripod attachment 50. It should be understood, icons 36 are spaced from viewfinder 10 and clamp 16.

Continuing to refer to FIG. 1, phone 12 may comprise a phone body 32 and a screen 34. Software enabling a camera function on phone 12 may create icons 36 on the screen 34 for camera control. The image 46 and icons 36 may be spaced from each other. Icons 36 represent areas on the screen 34 to control the camera function of the phone 12 such as ‘take image’ command.

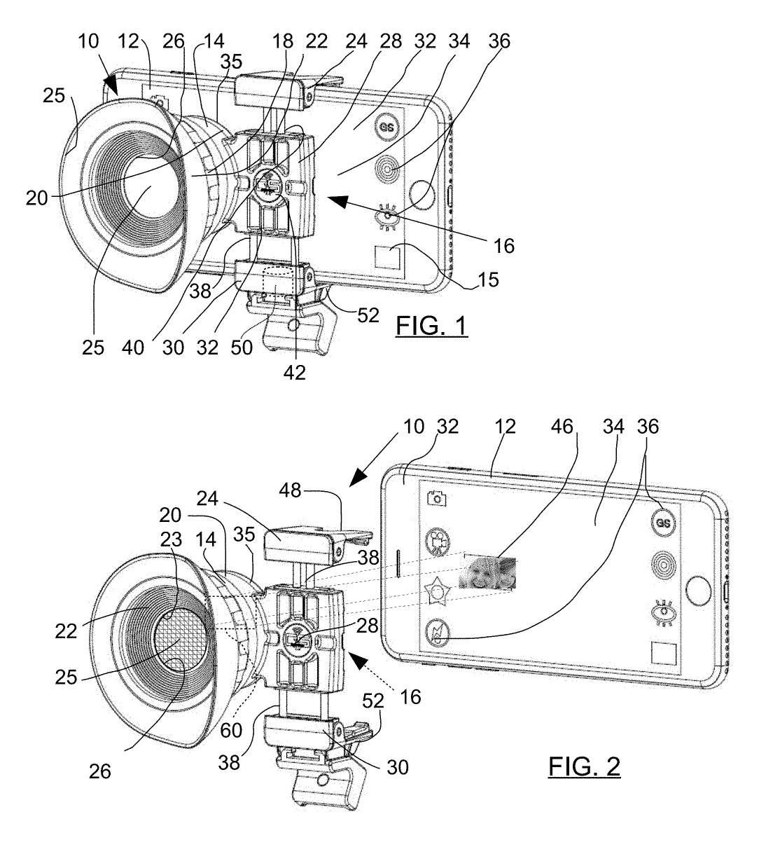

Referring to FIG. 2, image 46 may be disposed on screen 34 at a predetermined position. Image 46 is disposed at a predetermined position spaced from icons 36 and aligned with sight channel 26. First grip 24 may further comprise finger 48 for engaging phone 12. Second grip 30 may further comprise resilient pad 52 bearing against phone 12.

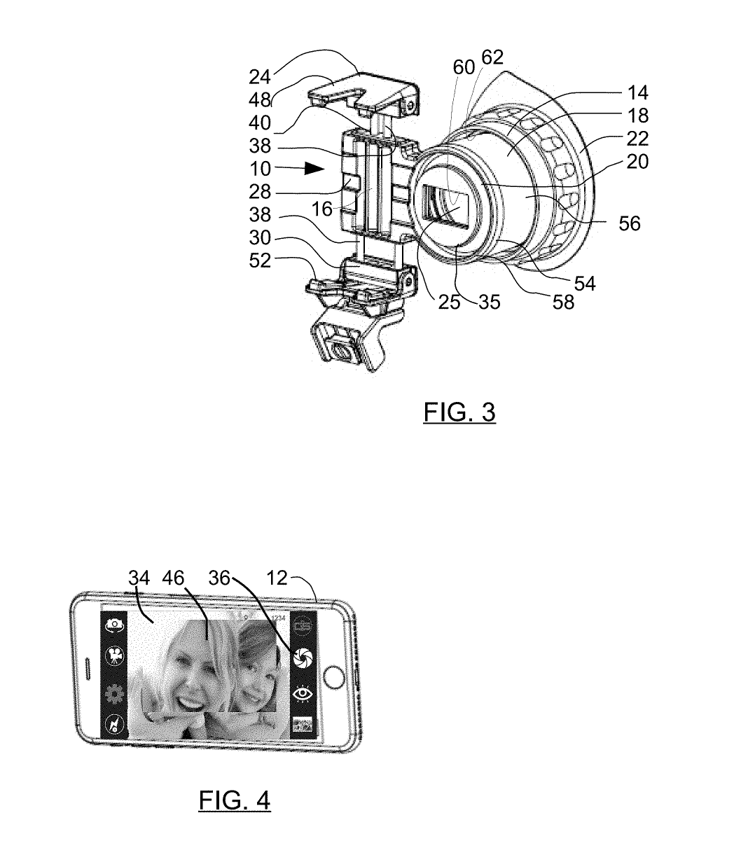

Referring to FIG. 3, image 46 generally covers screen 34 having icons 36 disposed over image 46.

Referring to FIG. 4, image 46 on screen 34 is adapted to a predetermined size and position by software application. Image 46 may be re positioned by software application to align image with sight channel 26 on viewfinder 10 (FIG. 2).

Referring to FIGS. 1-4, Software application identifies size of image 46 by information input by user concerning hood 20 size, optical lens 25 on sight channel 26 and screen 34 characteristics. Software also configures icons 36 at predetermined positions on screen 34 spaced from image 46. Implementation of software application with eyepiece 14 and camera 12 may comprise the steps of:
Step 1. Identify screen 34 size
Step 2. Identify viewfinder 10 type
Step 3. Identify sight channel 26 size.
Step 4. Identify optical element 25.
Step 5. User select image size.
Step 6. User select camera controls to be displayed.
Step 7. Select right hand mode or left hand mode.
Step 8. User select thumb or finger control.
Step 9. User select orientation (portrait or landscape)
Step 10. Attach eyepiece 14 to camera 12.
Step 11. Adjust boot 20 position on screen 34.
Step 12 Adjust image 46 position with fine adjust tools.
Step 13. Adjust image 46 size.

Software application has icons 34 such as arrows to adjust size and position of image 46. In use, application software is configured to approximate the size and position of image 46. Eyepiece 14 may be attached to camera 12 having boot 20 on screen 34. Sight channel 26 is aligned between optical element lens 25 and image 46. Sight channel 26 extends through viewfinder body 18 to form light sealed sight channel 26. Eye-cup 22 is selected to conform to user's face (not shown) User's eye is disposed adjacent optical lens 25 having eye-cup 22 sealingly on user's face thereby providing a sight channel 26 isolated from ambient light from user's eye to boot 20. Boot 20 surrounds image 46 and bears against screen 34 in a predetermined position with software configured icons spaced from boot 20. Clamp body 28 is disposed spaced from icons 36. Eye-cup 22 is spaced from screen 34 a predetermined distance greater than the distance from the user's cheek to the tip of the users nose. Viewfinder body 18 may have a threadable engagement to eye-cup 22 to allow adjustment of spacing between optical element 25 and screen 34.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

We claim:

1-14. (canceled)

15. A viewfinder for use with a phone, the phone having a screen and a camera function, the viewfinder comprising:
an eyepiece, the eyepiece comprising a body, a lens, an eye-cup, and a hood, the body comprising an inside and an outside, the eye-cup on the body, the hood on the body, the hood spaced from the eye-cup, a sight channel on the inside, the sight channel comprising an opening in the body, the sight channel extending from the eye-cup to the hood, the eye-cup surrounding the cup opening, the hood surrounding the screen opening, the hood between the body and the screen, the hood bearing against the screen, whereby the sight channel forms a visual pathway from the eye-cup to the screen;
a clamp, the clamp on the body, the clamp on the phone,
a software application, the software application adapted to capture an image from the camera function, the software application adapted to display the image on the screen and dispose the image adjacent the hood.

16. The viewfinder of claim 15, further comprising a threadable engagement, the threadable engagement on the body attached to the eye-cup.

17. The viewfinder of claim 15, wherein the hood further comprises light proof seal on the screen, the light proof seal surrounding the image.

18. The viewfinder of claim 15, wherein the software application is adapted to adjust the size of the displayed image 1.

19. The viewfinder of claim 18, wherein the software application further comprises a camera control icon displayed on the screen.

20. The viewfinder of claim 19, wherein the software application is further adapted to dispose the camera control icon in spaced relation to the hood.

21. The viewfinder of claim 15, wherein the eye-cup is adjustably attached to the body.

22. The viewfinder of claim 15, wherein the hood is adjustably attached to the body.

23. The viewfinder of claim claim 21 wherein the hood is adjustably attached to the body.

24. The viewfinder of claim 15 wherein the sight channel is sealed against ambient light in the body.

25. The viewfinder of claim 24 further comprising an eye-cup opening on the eye-cup, the sight channel is sealed against ambient light between the hood and the eye-cup opening.

26. The viewfinder of claim 1, further comprising a support attachment on the viewfinder body.

27. A viewfinder for use with a phone, the phone having a screen, and a camera function, the viewfinder comprising:
an eyepiece, the eyepiece comprising a hollow body, a lens, an eye-cup and a hood, the hollow body comprising an inside, an outside and a light sealed sight channel, the light sealed sight channel in the body, the light sealed sight channel having a cup opening and a hood opening, the eye-cup on the outside, the eye-cup in visual communication with the screen, the hood on the body, the hood spaced from the eye-cup, the hood bearing against the screen, the lens disposed in the light sealed sight channel; and
a clamp, the clamp on the body, the clamp attached to the phone.

28. The viewfinder of claim 27, further comprising a software application in the phone, the software application adapted to adjustably capture, display and record an image, the software application is adapted to capture and image from the camera function and display the image on the screen adjacent the screen end, the software application is further adapted to display camera control icons on the screen.

29. The viewfinder of claim 27, wherein the body is adjustably attached to the eye-cup.

30. The viewfinder of claim 27, wherein the hood surrounds the screen opening, the hood bearing against the screen,.

31. The viewfinder of claim 27, further comprising a threadable engagement on the hood.

32. The viewfinder of claim 28, wherein the eye-cup is in visual communication with the screen, the software application adapted to display the image on the screen, the image adjacent the hood whereby the image is in visual communication with the eye-cup

33. A smart phone viewfinder comprising:
a body, the body having an inside and an outside, a sight channel in the body, the sight channel comprising an eye-cup opening and a hood opening, a lens in the sight channel;
an eye-cup, the eye-cup on the body adjacent the sight channel, the eye-cup surrounding the eye-cup opening;
a hood, the hood comprising a light proof pad, the hood on the body adjacent the sight channel, the hood surrounding the hood opening the light proof pad on the hood, the light proof pad on the screen, the hood between the light proof pad and the body; and
a software application in the body, the software application adapted to display an image adjacent the hood opening.
